(19) United States
(12) Patent Application Publication
(10) Pub. No.: US 2009/0020463 A1
(43) Pub. Date: Jan. 22, 2009

(54) TRIPLE-CHANNEL PARTICLE SEPARATION DEVICE

(76) Inventors: Horn-Jiunn Sheen, Taipei City (TW); Ching-Jiun Lee, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/779,283

(22) Filed: Jul. 18, 2007

(51) Int. Cl. B01D 35/14

(52) U.S. Cl. 210/86

(57) ABSTRACT

A triple-channel particle separation device suitable for separating particles from the two-phase suspension is provided. The present device includes a body and a vibrating element. The vibrating element is placed on the surface of the body. The suspension is suitable for being contained in an inlet chamber of the body, and the fluids are liquid. The junction of triple channels has one inlet end and three outlet ends. The inlet end of the junction of triple channels is connected to the transport channel for the suspension and the three outlet ends are connected to one center outlet channel and two side outlet channels. The two side outlet channels are disposed on two sides of the center outlet channel. When the particle separation device is in use, the suspension fluids first go through the transport channel. Then, the particles may be removed and led to the two particle side outlet channels.

### CROSS-REFERENCE TO RELATED APPLICATION

This application claims the priority benefit of Taiwan. The invention is entitled: TRIPLE-CHANNEL PARTICLE SEPARATION DEVICE, filed on Jul. 18, 2006. The inventors are Sheen, Horn-Jiunn and Lee, Ching-Jiun. All disclosure of the Taiwan application is incorporated herein by reference.

### BACKGROUND OF THE INVENTION

1. Field of the Invention

The present invention integrates a two-phase suspension flow directing device and a trifurcate zone into a new triple-channel separator for particle removal. The suspension, which includes liquid and particles, may be pumped from the inlet chamber and the particles may be removed into the side outlet channels.

2. Description of Related Art

Particle separators are essential components in micro-total-analysis-systems (μ-TAS) and are widely used in bio-chemical and biomedical applications. One of the key issues in developing these systems is how simple and high separation performance can be achieved. In the previous studies, two noncontact technologies, dielectrophoresis (DEP) and acoustic wave, were the most frequently used approaches for particle separation in suspension. DEP is the lateral movement of particles induced by polarization effects in non-uniform electric fields. In the DEP devices, mixing particles are injected into a separation chamber and an electric field is applied for separation. The particles are separated on the basis of sizes and DEP properties. Theoretical studies on acoustic radiation forces indicated that a rigid and compressible sphere in a nonviscous fluid can be trapped in such a field. The efficacy of using acoustic force to concentrate small particles in suspension has also been evaluated theoretically and experimentally. That this method could be used to separate particles continuously in a micro-channel was proposed. Those devices adopted acoustic wave and operated in a half wavelength standing wave field.

In addition, a special design in the geometry of the micro-channel, such as a pinched flow fractionation (PFF), has been used to separate and filter particles of different sizes. Filtration has a critical drawback, namely clogging in the channel, which makes it impossible to separate repetitively. A new hydrodynamic filtration method was developed to avoid this clogging problem, but precise channel geometry and flow rate controls are necessary. While a variety of separators have been studied with DEP, acoustic wave, and PFF in the laminar flow, the oscillating flow generated from a micropump has received much less attention. However, in the miniaturization of bio-detecting applications, the micropump is a necessary component in the system. The flow pattern in the micro-channel is an oscillating flow, not a laminar flow. The flow characteristics of an oscillating flow in the micro-channel were used to achieve particle removal without an external pumping source. The distinct feature makes the present device ideal for a portable μ-TAS or lab-on-a-chip.

The objective of this patent is to develop a triple-channel particle separation device that can remove the particles from the suspension. The device can be utilized for applications in biomedical and chemical analyses, such as removing red blood cells from the whole blood. This device has been successfully demonstrated to be able to pump fluid and to remove particles without any external pumping devices. This is a definite advantage over other separation techniques such as DEP, acoustic force and PFF, which require a syringe pump or other external driving source. The present device can be fabricated by a simple MEMS process which requires only one photo mask and one ICP etching process. This process not only simplifies the complicated processes of producing separators used in the previous studies but also reduces the cost and enhances the yield. Due to the reduced volume of the particle separating system, the present separator has the potential to be integrated with other detectors for uses in a miniaturized μ-TAS in the future.

### SUMMARY OF THE INVENTION

Accordingly, the present invention is directed to a triple-channel particle separation device, which has a low manufacturing cost and a better separation effect.

The present invention is further directed to a particle separating method, which is applicable for using the triple-channel particle separation device to separate particles in micro-scale.

As embodied and broadly described herein, the present invention provides a triple-channel particle separation device, which is suitable for separating particles within two-phase suspension. The triple-channel particle separation device includes a body and a vibrating element. The body has an inlet chamber, a vibration chamber, a transport channel for suspension, a junction of triple channels, a center outlet channel, two side outlet channels, a center outlet chamber, two side outlet chambers, a flow directing device, and a taper.

The inlet chamber of the body is suitable for accommodating the two-phase suspension and the fluids are liquid. One end of the flow directing device of the body is connected to the inlet chamber, and the other end is connected to a vibration chamber. A taper of which the cross section close to the vibration chamber is smaller than that away from the vibration chamber. The taper is disposed on an inner wall of the channel within the flow directing device of the body. One end of the transport channel for the suspension of the body is connected to the vibration chamber, and the other end is connected to the junction of the triple channels. One end of the center outlet channel is connected to the center outlet chamber, and the other end is connected to the junction of the triple channels. One end of the particle outlet channel is connected to the side outlet chamber, and the other end is connected to the junction of the triple channels. The two side outlet chambers are disposed on two sides of the center outlet chamber, and the outlet chambers are suitable for accommodating the fluids and the particles. The vibrating element is disposed on the surface of the body, and the position of the vibrating element corresponds to the vibration chamber. The vibrating element is suitable for receiving an electronic signal to generate vibration, and the volume of the vibration chamber is changed through the amplitude of vibrating element, so as to pump the fluids from the inlet chamber to the outlet chambers of the body.

The triple-channel particle separation device of the present invention is a particle-separating mechanism developed by utilizing the vibration of the vibrating element to drive fluids to flow through the flow directing device and to generate an oscillating flow field in conjunction with the geometrical parameters of the triple-channeled intersection. Under the condition of oscillating flow field, when the fluid flows through the junction of triple channels, three phenomena are generated, which make the particles move towards the side outlet channels at two sides. Firstly, when the fluid flows in the transport channel, the particles move towards the two sides of the channel. Next, when the fluids move to the junction of triple channels, the velocity is reduced due to the enlarged cross sectional area, and two recirculation zones are generated at the two sides, which drives particles to move towards two sides of the junction of triple channel, and finally, a pair of vortices are be generated behind the inlet of the center outlet channel. These vortices may serve as stoppers to block the progressing of particles, thus reducing the cross sectional area of the central outlet channel and increasing the flow resistance. Moreover, since the rotation direction of vortex is from the center outlet channel to the side outlet channels, the particles are driven to move towards the outlet channel on the two sides. Under the effect of the above three phenomena, the particles can be separated effectively.

In an embodiment of the present invention, the body includes an upper substrate and a lower substrate, in which the upper substrate is disposed on a bonding surface of the lower substrate.

In an embodiment of the present invention, the upper substrate has a first recess pattern. The first recess pattern forms an inlet chamber, a vibration chamber, a center outlet chamber, two side outlet chambers, a junction of triple channels, a transport channel for suspension, a center outlet channel, two side outlet channels, a flow directing device, and a taper between the upper substrate and the lower substrate.

In an embodiment of the present invention, the upper substrate has a first recess pattern, and the lower substrate has a second recess pattern. The first recess pattern and the second recess pattern from a inlet chamber, a vibration chamber, a center outlet chamber, two side outlet chambers, a junction of triple channels, a transport channel for suspension, a center outlet channel, two side outlet channels, a flow directing device, and a taper between the upper substrate and the lower substrate.

In an embodiment of the present invention, the vibrating element is a piezoelectric film.

In an embodiment of the present invention, the triple-channel particle separation device further includes a plurality of inlet chambers disposed at the inlet end of the body.

In an embodiment of the present invention, the triple-channel particle separation device further includes a plurality of flow directing devices disposed at the inlet end of the body.

According to the present invention, the vibrating element is disposed on the surface of the body, and the flow directing device is disposed at one end of the vibration chamber. When a vibration period for the vibrating element is completed, the vibrating element can drive the fluids to move towards a fixed direction. Therefore, the suspension in the body may move towards a fixed flow direction under the vibration effect of the vibrating element. Additionally, the present invention utilizes the junction the triple channels for connecting the transport channel, the center outlet channel, and the two side outlet channels, and therefore the present invention may drive the fluids to flow through the flow directing device by utilizing the vibration of the vibrating element and generate an oscillating flow field, so as to separate the particles contained in the fluids into the side outlet channels on the two sides.

In order to make the aforementioned and other objects, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of a triple-channel particle separation device according to an embodiment of the present invention.

FIG. 1B is a schematic sectional view of FIG. 1A taken along the section line A-A′.

FIG. 1C is a schematic sectional view of FIG. 1A taken along the section line B-B′.

FIG. 1D is a physical diagram of the particle separation device according to an embodiment of the present invention.

FIG. 2A is a schematic view of the movement of the particles under the effect of the oscillating flow field in the junction of the triple channels of the particle separation device of the present invention.

FIG. 2B shows the measurement result of the oscillating flow field with the particle image velocimetry in the junction of the triple channels of the particle separation device of the present invention.

FIG. 3A shows the condition of injecting the suspension into the triple-channel particle removal device with a syringe pump, in which the particles are distributed in the three channels.

FIG. 3B shows the actual operation results of the triple-channel particle separation device of the present invention, in which the particles in the suspension move towards the side outlet channels on the two sides, so as to be separated.

### DESCRIPTION OF EMBODIMENTS

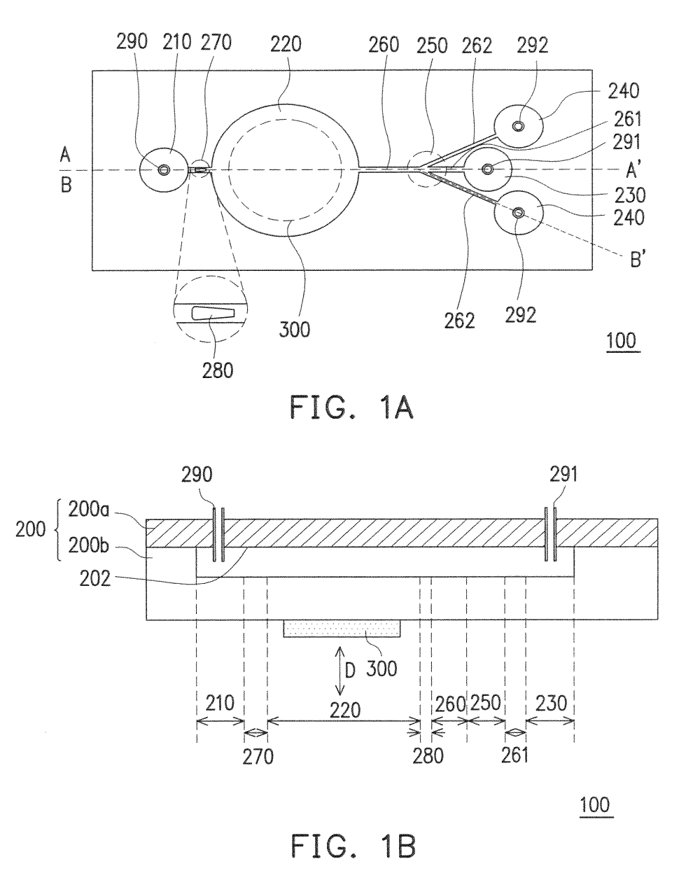

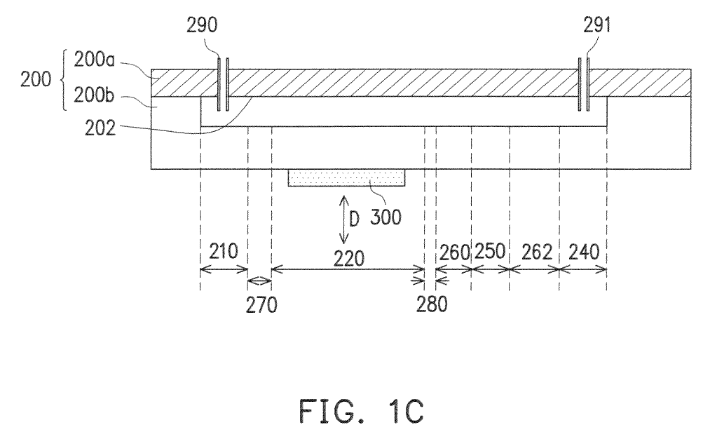

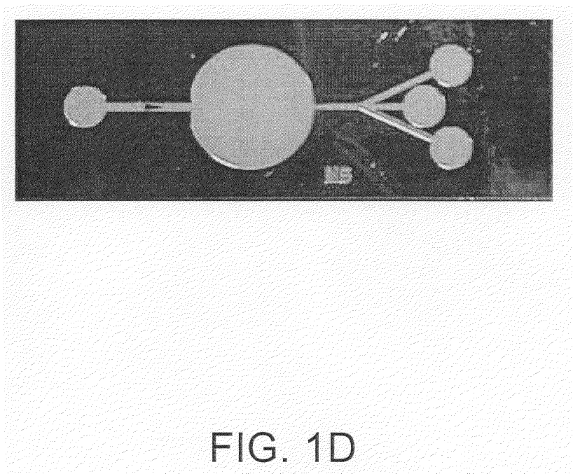

FIG. 1A is a schematic top view of a triple-channel particle separation device according to an embodiment of the present invention. FIG. 1B is a schematic sectional view of FIG. 1A taken along the line A-A′. FIG. 1C is a schematic sectional view of FIG. 1A taken along the line B-B′. FIG. 1D is a physical diagram of the triple-channel particle separation device. Referring to FIGS. 1A, 1B, 1C, and 1D, a triple-channel particle separation device 100 is suitable for separating particles contained in the suspension, in which the fluids are liquid. The triple-channel particle separation device 100 mainly includes a body 200 and a vibrating element 300. The body 200 mainly includes an upper substrate 200a and a lower substrate 200b. The upper substrate 200a is disposed on a bonding surface 202 of the lower substrate 200b, and the upper substrate 200a and the lower substrate 200b are made of, for example, glass, silicon wafer, acryl, polymethyl methacrylate (PMMA), polydimethyl siloxane (PDMS) or the like.

The lower substrate 200b has a recess pattern located on a bonding surface 202 of the lower substrate 200b, and the recess pattern forms a inlet chamber 210, a vibration chamber 220, a center outlet chamber 230, two side outlet chambers 240, a junction of triple channels 250, a transport channel for the suspension 260, a center outlet channel 261, two side outlet channels 262, a flow directing device 270, and a taper 280 between the upper substrate 200a and the lower substrate 200b.

It should be noted that, this embodiment is not used to limit the present invention, and in other embodiments of the present invention, the recess pattern can be further formed on the upper substrate 200a. Additionally, in another embodiment of the present invention, the upper substrate 200a and the lower substrate 200b may both have recess patterns.

The inlet chamber 210 is suitable for accommodating the suspension, and the fluids are liquid. One end of the flow directing device 270 is connected to the inlet chamber 210, and the other end is connected to the vibration chamber 220. One end of the transport channel for the suspension 260 is connected to the vibration chamber 220, and the other end is connected to the junction of the triple channels 250.

Additionally, in the present invention, the body 200 merely has an inlet chamber 210 and a flow directing device 270 disposed therein, and the number of the inlet chamber 210 and the flow directing device 270 is not limited in the present invention. The body 200 may further have a plurality of inlet chambers 210 and flow directing devices 270 with the same number.

The vibrating element 300 is disposed on the surface of the lower substrate 200b, and the position of the vibrating element 300 corresponds to the vibration chamber 220. The vibrating element 300 is, for example, a piezoelectric film, and suitable for receiving an electronic signal to generate harmonic vibrations in the vibrating direction D. The waveform of the electronic signal is, for example, a square wave or other signal waveforms that can make the vibrating element 300 generate the harmonic vibrations in the vibrating direction D. Additionally, although the lower substrate 200b merely has a vibrating element 300 disposed on the surface thereof in this embodiment, to the number of the vibrating element 300 is not limited in the present invention. The upper substrate 200a may also have a vibrating element on the surface thereof.

In this embodiment, the triple-channel particle separation device 100 further includes an injection pipe 290, a center outlet pipe 291, and two side outlet pipes 292. The injection pipe 290 penetrates through the upper substrate 200a to be communicated with the inlet chamber 210, the center outlet pipe 291 penetrates through the upper substrate 200a to be communicated with the center outlet chamber 230, and the side outlet pipes 292 penetrate through the upper substrate 200a to be communicated with the side outlet chamber 240. In this way, when the vibrating element 300 receives an electronic signal to generate vibrations, the suspension flow into the inlet chamber 210 via the injection pipe 290, the fluids can be removed out of the triple-channel particle separation device 100 via the outlet pipe 291, and the particles can be removed out of the triple-channel particle separation device 100 via the outlet pipe 292, and the action mechanism of the triple-channel particle separation device is illustrated below in great detail.

Under the condition of oscillating flow field, when the fluid flows through the junction of triple channels, three phenomena are generated and make the particles move towards the side outlet channels on the two sides. Firstly, when the fluid flows in the transport channel, the particles move towards the two sides of the channel. Next, when the fluids move towards the junction of triple channels, the velocity is reduced due to the enlarged cross sectional area, and two recirculation zones are generated at the two sides. The recirculation zone drives the particles to move towards the two sides of the junction of triple channels, and finally, a pair of vortices is generated behind the inlet of the center outlet channel. The vortex can serve as a stopper to block the progressing of the particles, and thus, reducing the cross sectional area of the center outlet channel and enhancing the flow resistance. Moreover, since the vortex is rotated from the center outlet channel to the side outlet channel on the two sides, the particles are driven to move towards the side outlet channel on the two sides. Under the three phenomena, the particles removal effect can be achieved effectively. As the geometrical shape of the channel affects the position of the generated vertex flow field and further influences the separation efficiency, the geometrical shape of the junction of the triple channels is the key point in designing the device of the present invention.

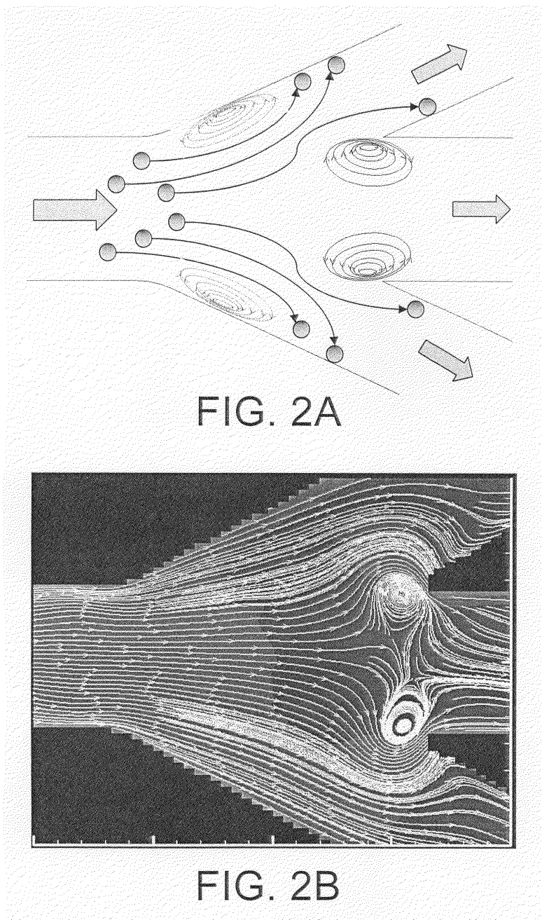

Through using the measurement technique of micro particle image velocimetry, the flow field characteristics for the junction of the triple channels can be obtained to explain the reasons for the particle separation. FIG. 2A is a schematic view of the movement of the particles in the junction of triple channels in the oscillating flow field. In FIG. 2A, it can be found that the particles move towards the side outlet channels on the two sides under the effect of the flow field. FIG. 2B shows the measurement result of the oscillating flow field in the junction of the triple channels. In FIG. 2B, it can be found that vortices occur behind the inlet of the center outlet channel in the junction of triple channels. The triple-channel particle separation device of the present invention utilizes the vortices to serve as a stopper, and since the vortices occur behind the inlet of center outlet channel, the cross sectional area of the center outlet channel is reduced and the flow resistance is increased. Furthermore, since the vortices rotates from the center outlet channel to the side outlet channels, the particles are driven to move towards the side outlet channels at the two sides, and thus, the particles contained in the suspension are successfully separated.

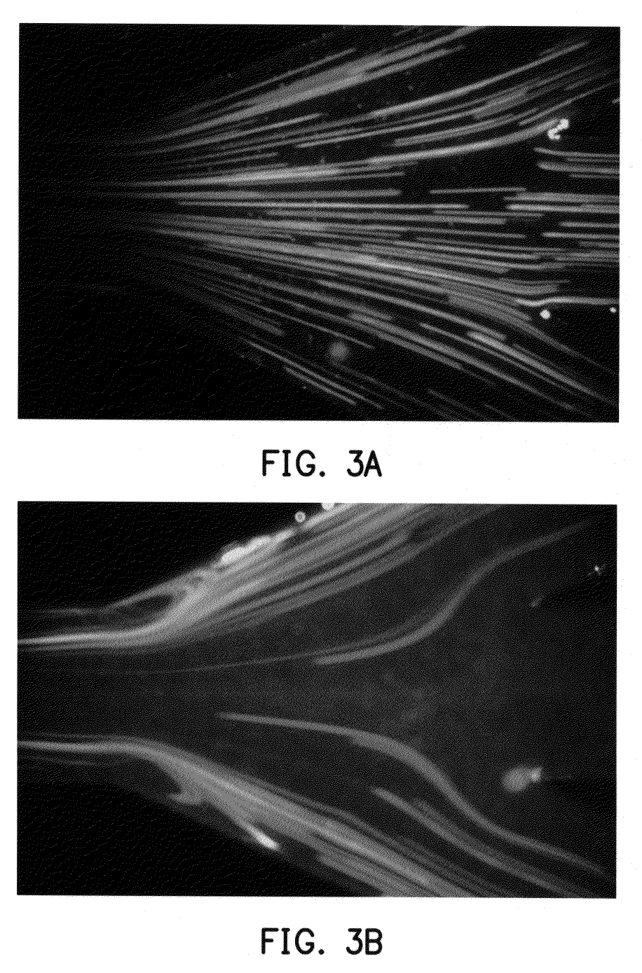

In order to prove the feasibility of the present invention, the triple-channel particle separation device is tested and the movement of the particles within the channel is photographed, in which the work fluid is de-ionized water containing fluorescent particles. FIG. 3A shows the condition of injecting the suspension into the micro channel with a syringe pump. As shown in FIG. 3A, it can be seen clearly that the particles are distributed in three channels. FIG. 3B shows the actual operation results of the triple-channel particle separation device of the present invention, in which the movement of the particles in the fluids is photographed by utilizing the particle image velocimetry. The result shows that when flowing through the junction of the triple channels, the particles contained in the suspension move towards the side outlet channels on the two sides, instead of being driven towards the center outlet channel. It can be known that the removal efficiency is better, and the particles removal effect can be achieved indeed.

To sum up, the triple-channel particle separation device of the present invention at least has the following advantages:

(1) The present invention utilizes the vortices to remove the particle from the suspension. The vortices are generated when the oscillating flow field flows through the junction of the triple channels. Therefore, the different triple channel angle can be designed in the present invention to meet the different requirements for the particle removal without any additional apparatus.

(2) The volume of the vibration chamber is changed by using a vibrating element in the present invention, so as to drive the fluids in the triple-channel particle separation device. Therefore, it is not necessary for the present invention to connect to any external pumping source, for example, a syringe pump. Additionally, a portable power supply can also be used in the present invention, so that it is convenient to carry along the device of the present invention. Furthermore, the sensors can also be combined with this present device, so that the present invention has the effect of real-time detection.

(3) The present invention has a simple structure, and thus has the advantage of a low manufacturing cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A triple-channel particle separation device, applicable for separating particles in suspension, comprising:
a body, comprising:
an inlet chamber, for accommodating the suspension;
a vibration chamber;
a flow directing device, with one end being connected to the inlet chamber, and the other end being connected to the vibration chamber;
a taper, disposed on an inner wall of the flow directing device, and having a cross section close to the vibration chamber being smaller than that away from the vibration chamber;
a transport channel for suspension, with one end being connected to the vibration chamber, and the other end being connected to a junction of triple channels;
a center outlet chamber;
two side outlet chambers;
a center outlet channel, with one end being connected to the center outlet chamber, and the other end being connected to the junction of the triple channels;
two side outlet channels, with one end being connected to the side outlet chamber, and the other end being connected to the junction of the triple channels; and
a vibrating element, disposed on a surface of the body, wherein the position of the vibrating element corresponds to the vibration chamber, the vibrating element is suitable for receiving an electronic signal to generate vibrations, and a volume of the vibration chamber is changed through the vibration, so as to pump the fluids from the inlet chamber to the outlet chambers.

2. The triple-channel particle separation device as claimed in claim 1, wherein the body includes an upper substrate and a lower substrate, and the upper substrate is disposed on a bonding surface of the lower substrate.

3. The triple-channel particle separation device as claimed in claim 2, wherein the lower substrate has a first recess pattern, and the first recess pattern forms the inlet chamber, the vibration chamber, the flow directing device, the transport channel for the suspension, the center outlet channel, the side outlet channels, the center outlet chamber, the side outlet chambers, and the junction of the triple channels between the upper substrate and the lower substrate.

4. The triple-channel particle separation device as claimed in claim 2, wherein the upper substrate has a first recess pattern, and the lower substrate has a second recess pattern; the first recess pattern and the second recess pattern form the inlet chamber, the vibration chamber, the flow directing device, the transport channel for the suspension, the center outlet channel, the side outlet channels, the center outlet chamber, the side outlet chambers, and the junction of the triple channels between the upper substrate and the lower substrate.

5. The triple-channel particle separation device as claimed in claim 1, wherein the vibrating element is a piezoelectric film.

6. The triple-channel particle separation device as claimed in claim 1, further comprising the other vibrating element, wherein the vibrating elements are respectively disposed above and below the vibration chamber.

7. The triple-channel particle separation device as claimed in claim 1, further comprising a plurality of inlet chambers and flow directing devices with the same number, and one end of the flow directing devices is connected to the vibration chamber.

8. The triple-channel particle separation device as claimed in claim 1, wherein the two-phase suspension fluids are liquid.
